(19) United States
(12) Patent Application Publication
(10) Pub. No.: US 2009/0296703 A1
(43) Pub. Date: Dec. 3, 2009

(54) Method and system for dynamic roaming across wireless networks

(75) Inventor: Tzu Hsi Peng, Taipei (TW)

Correspondence Address: Juan Carlos A. Marquez;c/o Stites & Harbison PLLC, 1199 North Fairfax Street, Suite 900, Alexandria, VA, 22314-1437, US

(73) Assignee: Ruby Tech Corp.

(21) Appl. No.: 12/155,188

(22) Filed: May 30, 2008

(51) Int. Cl. H04L 12/56

(52) U.S. Cl. 370/389

(57) ABSTRACT

The invention relates to a dynamic roaming technology across wireless networks. According to the invention, a mobile device can roam between different networks with seamless quality by utilizing a plurality of connections for dispatching packets of a task. The invention provides a capability of processing a huge amount of data such as real time video communication during roaming between different wireless communication systems with seamless quality.

### FIELD OF THE INVENTION

The present invention relates generally to wireless communication, and more specifically to technology for roaming between different networks with seamless quality by multiple dynamic connections.

### BACKGROUND OF THE INVENTION

As mobile communications grow, and as more and more users begin to transceive a great amount of data by mobile devices, the demand for roaming mobile communication with seamless communication quality grows. For any mobile device, roaming different networks with seamless session is a difficult technical problem.

Since the early development of wireless communication, wireless mesh networks have been the most topical application of mesh architectures. Wireless mesh was originally developed for military applications but has undergone significant evolution in the past decade. As the cost of radios plummeted, single radio products evolved to support more radios per mesh node with the additional radios providing specific functions, such as client access, backhaul service or scanning radios for high speed handover in mobility applications. Due to the increasing delay caused by multiple hops and the complexity of protocols and planning of initial coverage, wireless mesh network is going to be eliminated.

Meanwhile, Mobile IP is an Internet Engineering Task Force standard communications protocol that is designed to allow mobile device users to move from one network (Home Agent as a server) to another (Foreign Agent as a server) while maintaining a permanent IP address with a care-of address. The Mobile IP protocol allows transparent routing of IP datagrams on the Internet. Each mobile node is identified by its home address regardless of its current location on the Internet. While away from home, a mobile node is associated with a care-of address which gives information about its current location. Mobile IP specifies how a mobile node registers with its Home Agent and how the Home Agent routes datagrams to the mobile node through a tunnel established between the Home Agent and the Foreign Agent. By using Mobile IP, nodes may change their point-of-attachment to the Internet without changing their IP address. This allows them to maintain transport and higher-layer connections while moving.

However, Mobile IP faces some crucial technical problem such as hand-off issue and dependency between Home Agent/Foreign Agent. No matter what kind of hand-off is used, the general process of hand-off comprises: system discovery, hand-off decision, and handoff execution. System discovery includes detection of the mobile device when it is on the move. Hand-off decision is made according to the signal fading, signal noise, shadow fading, multi-path fading, path loss, etc. In addition, the Home Agent and the Foreign Agent must establish connection as any mobile device moves from one to the other. The connection is called “tunnel.” For example, as soon as the mobile device leaves the Home Agent network and enters the Foreign Agent network, the mobile device can receive a care-of address from the Foreign Agent's broadcasting. The mobile device must register the care-of address with the Foreign Agent or the Home Agent so that these two agents can establish the tunnel on the basis of the registration. Given the above, Mobile IP structure utilizes only one connection at a time, which is hard to transmit a huge amount of data (especially a burst of data during roaming) and is very difficult to provide a seamless communication for a mobile device.

As a result, all of the existing systems fail to provide a good capability of processing a huge amount of data such as real time video communication during roaming between different wireless communication systems with a seamless quality.

### SUMMARY OF THE INVENTION

The invention is provided to solve the above problems. The invention provides a network technology of dispatching packets of a task through multiple dynamic connections for roaming across wireless networks with seamless quality and a good capability of processing a huge amount of data during roaming smoothly.

According to an embodiment of the invention, a network device for dispatching packets of a task through a plurality of connections comprises at least a first and a second network interfaces, wherein said first network interface is configured to establish a first connection with a network node, said second network interface is configured to establish a second connection with said network node, and at least one of said at least first and second connections is wireless, wherein at least one of said network device and said network node is movable; and a transmitting unit configured to select a transmitting connection from said at least first and second connections to send a packet to said network node, wherein said transmitting connection has a relatively low latency, and said selection is performed repeatedly.

Since there are multiple connections established between the network device and the network node, it will be easy to transmit a burst of data, such as the data of a video communication, between the network device and the network node. In addition, if one of the connections is broken during a hand-off process, the other connection(s) still can provide a seamless communication for the network device. After the hand-off process, a newly established connection can cooperate with the other existing connection(s) to transmit data between the network device and the network node. Therefore, the invention can provide a dynamic roaming through wireless networks between different network systems with seamless quality and has a good capability of processing a huge amount of data during roaming smoothly.

According to an embodiment of the invention, a network system for dispatching packets of a task through a plurality of connections comprises a network node; and a network device configured to establish at least a first and a second connections with said network node and select a transmitting connection from said at least first and second connections to send a packet to said network node, wherein said transmitting connection has a relatively low latency, and said selection is performed repeatedly; wherein at least one of said at least first and second connections is wireless, and at least one of said network device and said network node is movable.

According to an embodiment of the invention, a network module to be used in an electronic device for dispatching packets of a task through a plurality of connections comprises a network unit for establishing at least a first and a second connections with a network node, wherein at least one of said at least first and second connections is wireless, and at least one of said electronic device and said network node is movable; and a transmitting unit for selecting a transmitting connection from said at least first and second connections to send a packet to said network node, wherein said transmitting connection has a relatively low latency and said selection is performed repeatedly.

According to an embodiment of the invention, a method for dispatching packets of a task from a first electronic device to a network node through a plurality of connections comprises establishing at least a first and a second connections between said first electronic device and said network node, wherein at least one of said at least first and second connections is wireless, and at least one of said first electronic device and said network node is movable; and selecting a transmitting connection from said at least first and second connections to send a packet from said first electronic device to said network node, wherein said transmitting connection has a relatively low latency and said selection is performed repeatedly.

According to an embodiment of the invention, a program product to be used in an electronic device for making said electronic device to perform the processes of establishing at least a first and a second connections between said electronic device and a network node, wherein at least one of said at least first and second connections is wireless and at least one of said electronic device and said network node is movable; and selecting a transmitting connection from said at least first and second connections to send a packet from said electronic device to said network node, wherein said transmitting connection has a relatively low latency and said selecting process is performed repeatedly.

According to a further embodiment of the invention, an interface device comprises a plurality of wireless interfaces with the same technology for establishing a plurality of connections with a network node.

### BRIEF DESCRIPTION OF THE DRAWINGS

FIG. 1 is a diagram illustrating a wireless network environment for dispatching packets between two network nodes in an embodiment of the present invention;

FIG. 2 is a block diagram of a network environment for two network nodes being connected.

FIG. 3 shows bidirectional packet flows of an IP session.

FIG. 4 shows bidirectional packet flows of an IP session according to an embodiment of the invention.

FIG. 5 shows packets go through TLCs between network nodes.

FIG. 6 shows packets go through TLCs between network nodes in the direction opposite to that shown in FIG. 5.

FIG. 7 shows packets having passed through the network nodes shown in FIG. 4.

FIG. 8 is a block diagram of a network environment showing different interfaces on a network node, with each linked to a next node under its respective network environment.

FIG. 9 shows how TLCs are established on the basis of underlying network links.

FIG. 10 shows how a TLC is established between network nodes.

FIG. 11 shows how a TLC is established with interface IP.

FIG. 12 shows a counterpart of the link shown in FIG. 11.

FIG. 13 shows a TLC between network nodes with IP information.

FIG. 14 shows 3 TLCs between two network nodes.

FIG. 15 shows a local network connected to each of the network nodes shown in FIG. 14.

FIG. 16 shows a packet flow with IP information.

FIG. 17 shows multiple TLCs between the two nodes shown in FIG. 16.

FIG. 18 shows how packets are dispatched across the TLCs shown in FIG. 17.

### DETAILED DESCRIPTION OF EXEMPLARY EMBODIMENTS

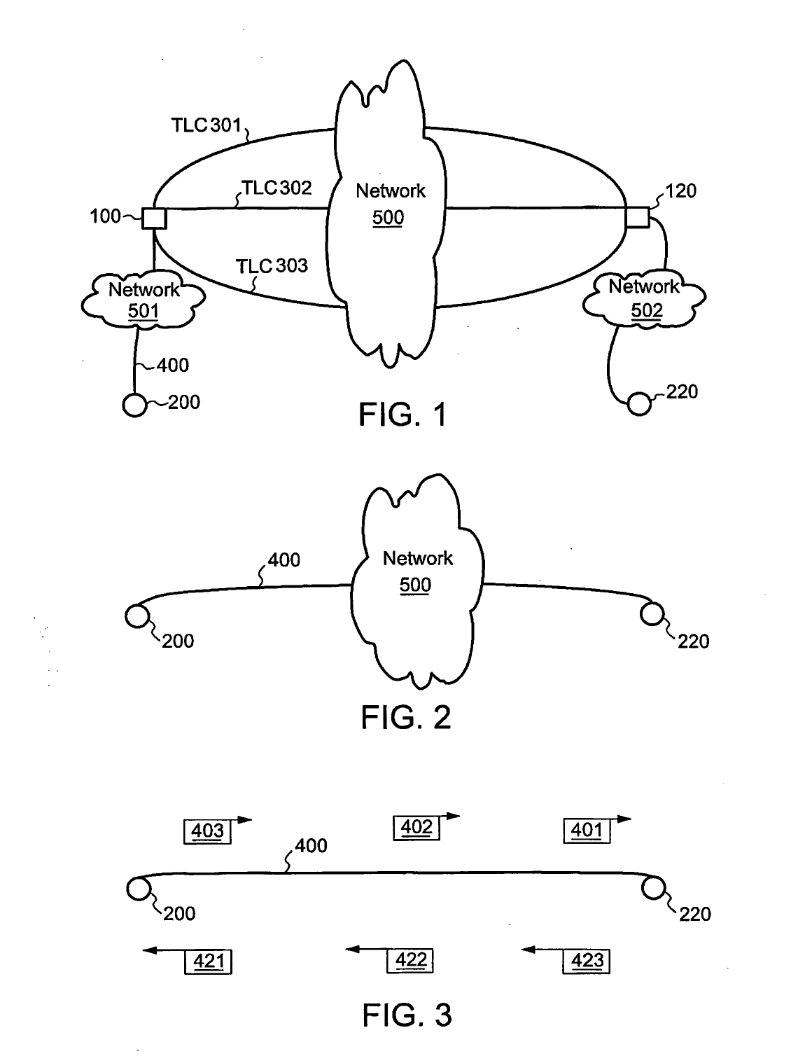

To keep the ongoing application session seamless between two network nodes under a wireless environment, a network technology of dispatching packets of a task through multiple dynamic connections for roaming across wireless networks is disclosed in the present invention. Referring to FIG. 1, a basic understanding of the network technology to solve the aforementioned problems is disclosed. FIG. 1 is a diagram illustrating a wireless network environment for dispatching packets between two network nodes in an embodiment of the present invention. The network environment comprises a network node 100 and a network node 120 connected with each other through multiple transportation layer connections (TLCs) 301, 302 and 303 via a network 500, wherein the multiple TLCs may be any tunnel connections using any type and form of tunneling protocol and/or any virtual private networking (VPN) connections using any type and form of VPN protocol, e.g. SSL VPN, as those skilled in the art can understand. Please note that, at least one of the network node 100 and the network node 120 is movable and/or roaming across networks under a wireless environment. When one of the connections TLC 301, TLC 302 and TLC 303 is broken, a new connection will be established to keep multiple dynamic connections between the network nodes 100 and 120. The network environment further comprises a network node 200 and a network node 220. The network node 200 connects with the network node 220 with an application IP session (AIS) 400 established, by using the network node 100 and the network node 120 as a gateway (or any intermediate network node that can be equipped to intercept the application IP session, as those skilled in the art can understand), wherein network 501 is a network between nodes 100 and 200, and network 502 is a network between nodes 120 and 220.

First, packets belonging to the AIS 400 are sent from network node 200 to the network node 100, and then the network node 100 dispatches the packets to the network node 120 through the multiple TLCs 301, 302 and 303, and then the network node 120 sends the packets to the network node 220, which is the destination of the packets. According to the embodiment, using multiple connections to send the packets of a task between two network nodes may increase the bandwidth of loading and maintain acceptable performance capability for the task. How those packets belonging to the AIS are dispatched will be described more clearly by referring to some of subsequent drawings.

In order to simplify the concept so that we can focus on the AIS, in FIG. 2, as compared to FIG. 1, any of the intermediary networks, gateways and the multiple connections, including 501, 502, 100, 120, 301, 302 and 303, are replaced by the network 500. That is, no matter how complicated the connection between the network nodes 200 and 220 is, the AIS 400 is merely an IP session established between network nodes 200 and 220. For example, in one embodiment, it may be a client server application model where the network node 200 is a client node and the network node 220 is a server node. In another embodiment, it may be a peer-to-peer application, for example, a real time VOIP (voice over internet protocol) application with one peer being the network node 200 and the other peer being the network node 220.

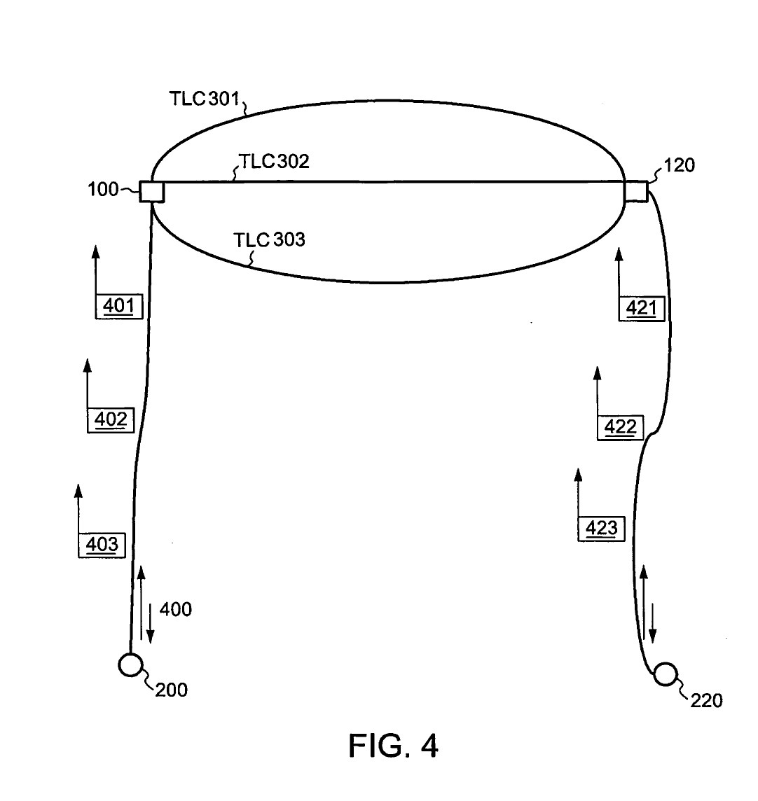

FIG. 3 shows the packets belonging to the AIS 400. In FIG. 3, the packets 401, 402 and 403 are sequentially transmitted from the network node 200 to the network node 220; the packets 421, 422 and 423 are sequentially transmitted from the network node 220 to the network node 200. For more detail, the intermediary network mediums as previously included in FIG. 1 are added to FIG. 4. In FIG. 4, the network nodes 100 and 120 act as a gateway (or any intermediate network node can be equipped to intercept AIS as those skilled in the art can understand) in a middle way toward their counterpart before the network node 200 and 220 respectively, and TLCs 301, 302 and 303 are multiple connections established with each end terminated at the network nodes 100 and 120 respectively for the network nodes 100 and 120 to route and dispatch packets:

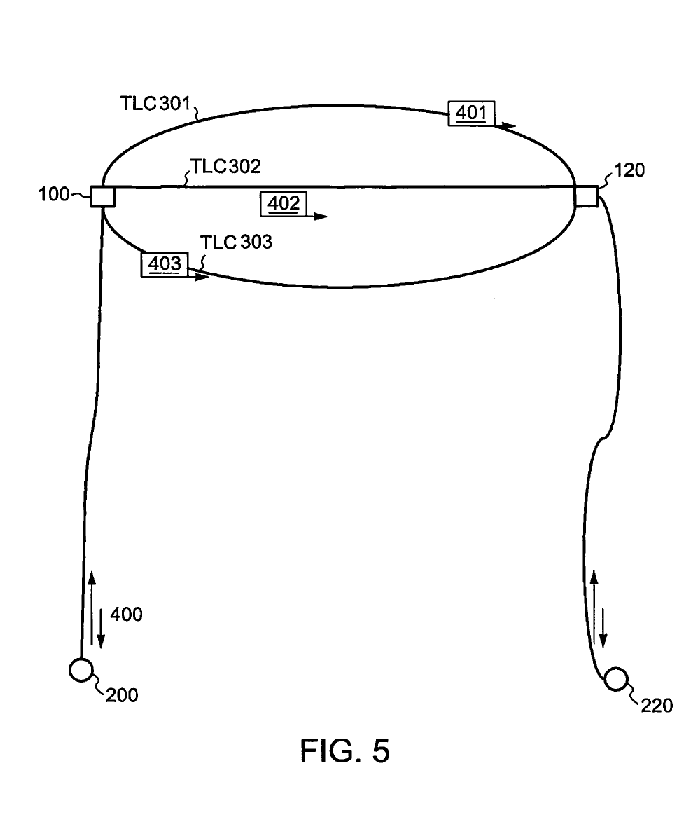

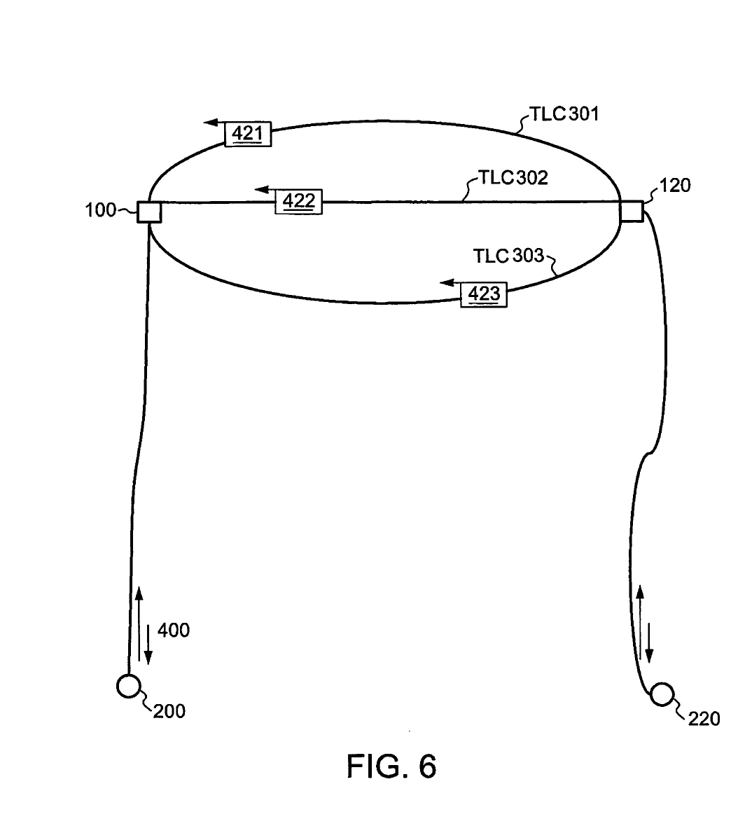

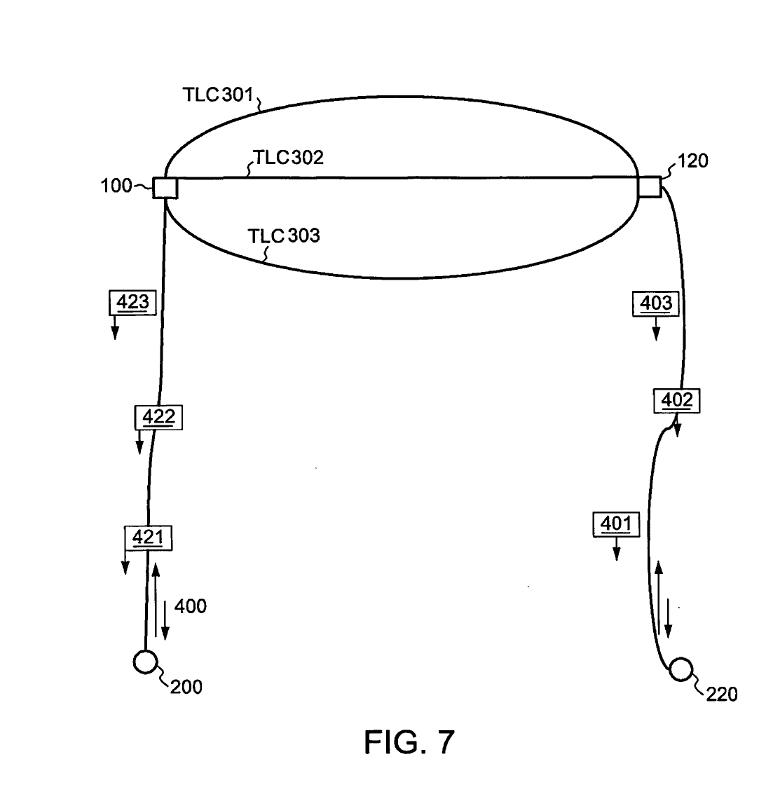

FIG. 5 shows the packets while and after entering the network node 100. In FIG. 5, a transmitting connection is selected from the TLCs 301, 302 and 303 to send the packets and the selection is performed repeatedly. For example, at first, TLC 301 is selected to send packet 401, then TLC 302 is selected to send packet 402, and then TLC 303 is selected to send packet 403. For the packet flow in the direction opposite to that shown in FIG. 5, as shown in FIG. 6, for example, TLC 301 is selected to send packet 421, TLC 302 is selected to send packet 422, and TLC 303 is selected to send packet 423. As shown in FIG. 7, after leaving the TLCs and the network nodes 100 and 120 respectively, the packets 401, 402 and 403, although previously separated, now continue destined to the network node 220; the packets 421, 422 and 423 now continue destined to the network node 200.

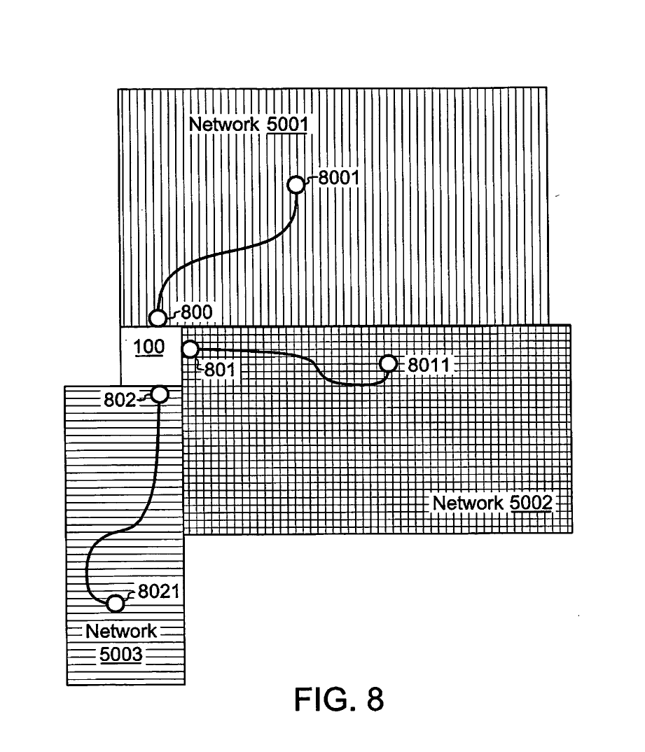

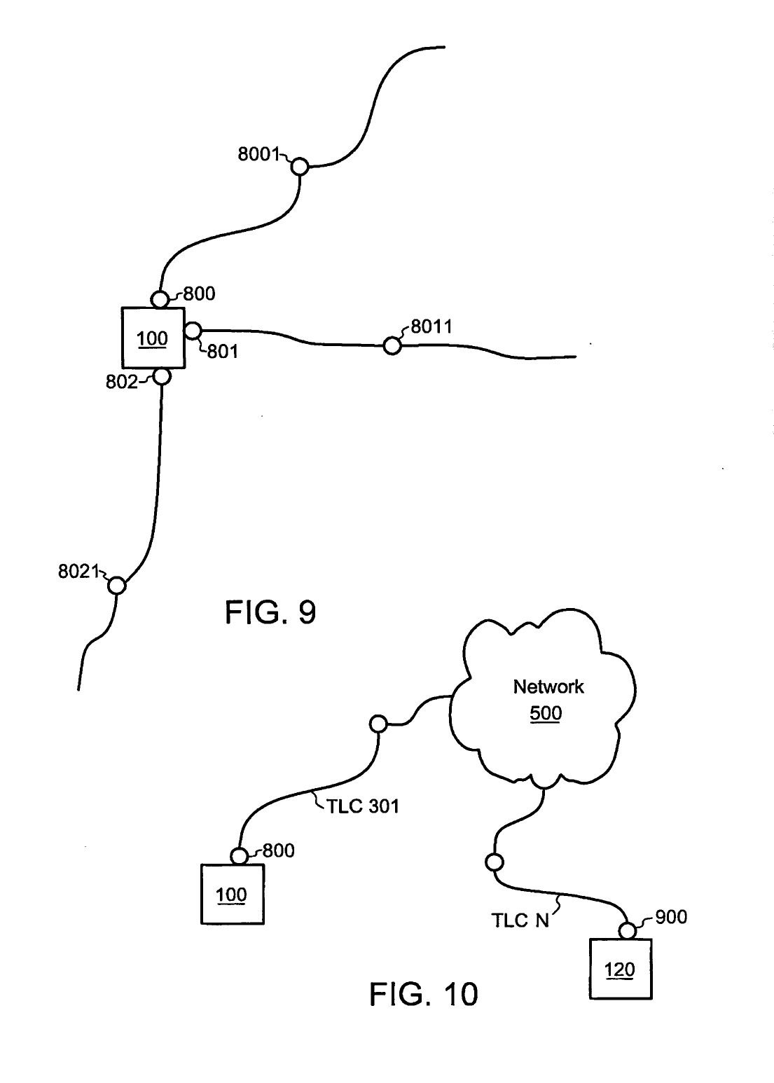

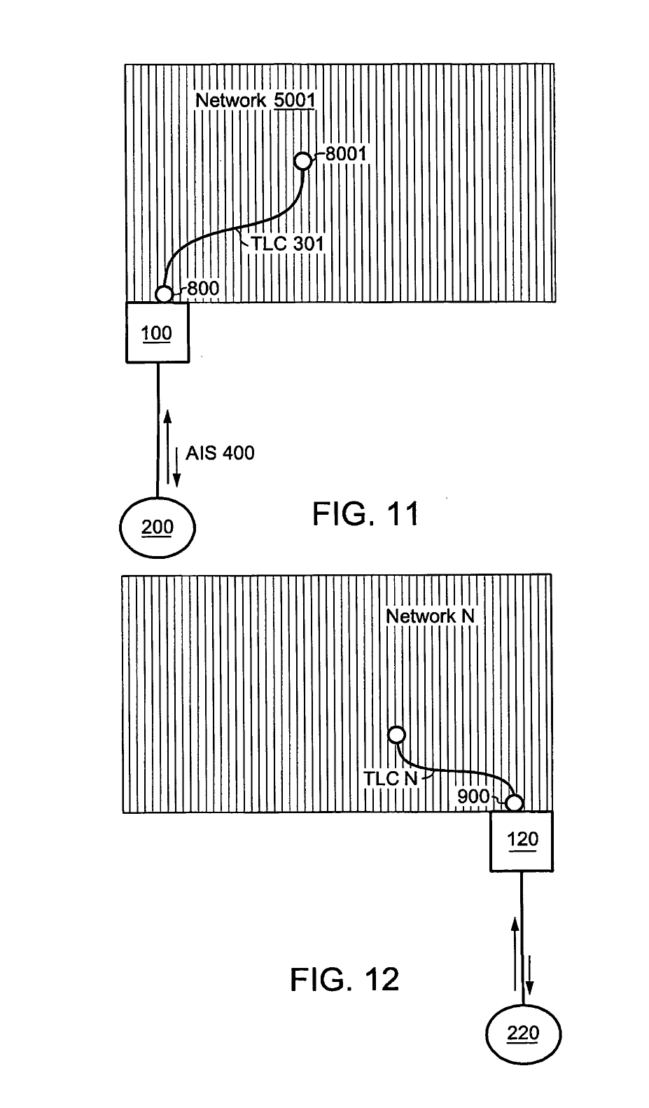

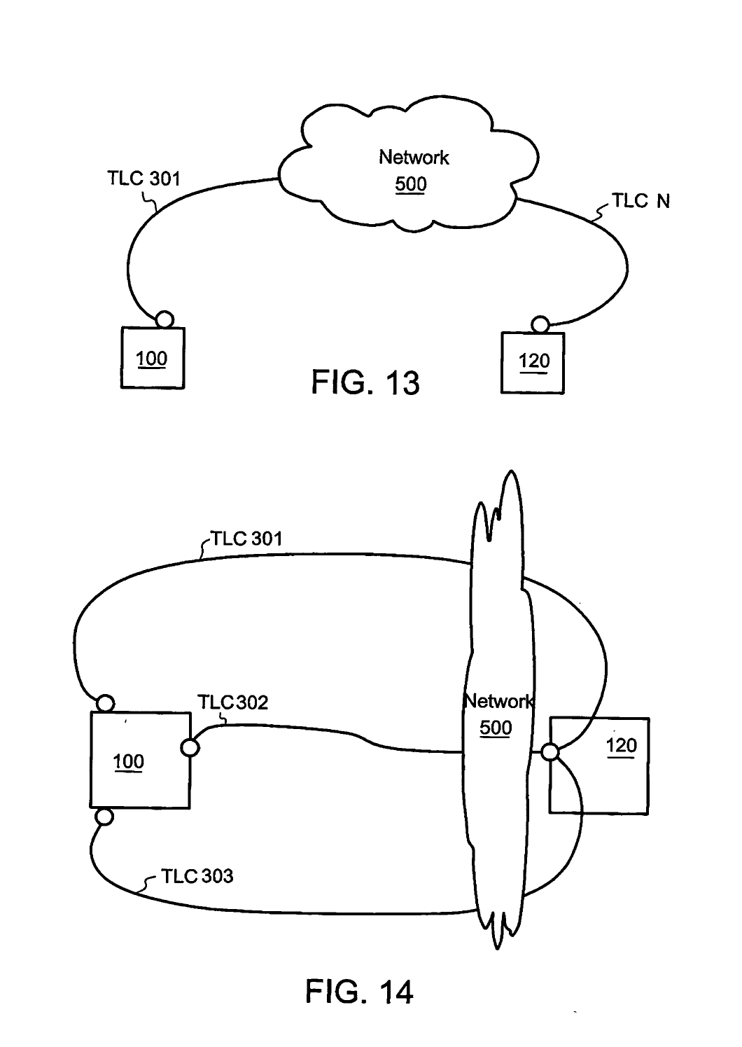

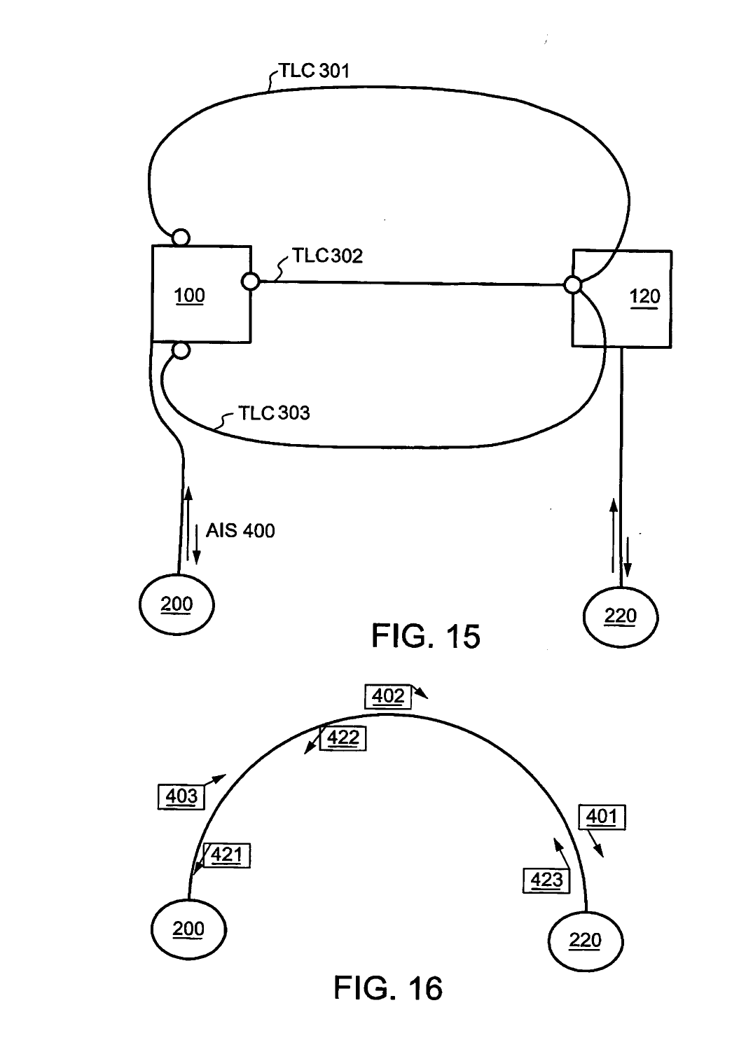

A method for packets to be transmitted through multiple TLCs while both the underlying layer links and the local network identifier (e.g. an Internet protocol (IP) address) are taken into account is disclosed as below. As shown in FIG. 8, there are three interfaces 800, 801 and 802 on the network node 100, each of which can be linked to the next network node 8001, 8011 and 8021 under its network environment network 5001, network 5002 and network 5003 respectively, wherein each of the interfaces 800, 801 and 802 may be virtual interface or physical interface. In one embodiment, such networks may be heterogeneous. For example, the network 5001 may be a 802.3 network, the network 5002 may be a WiFi (Wireless Fidelity) network and the network 5003 may be a PHS cellular phone network with PPP (point-to-point protocol) protocol thereon. No matter what network it is and what low-layer protocol runs on it, a local network identifier is configured on the physical or virtual interface used to establish TLC, as those skilled in the art can understand. In one embodiment, such networks may be homogeneous, for example, as all being WiFi networks. In FIG. 9, each of TLC 301, TLC 302 and TLC 303 is established on the basis of its underlying low-layer network link. In FIG. 10, a TLC established across the network 500 with each end terminated at the network node 100 and 120 respectively is based on an underlying link with the interface 800 in the network node 100 and interface 900 in the network node 120. In one embodiment, for example, when the applied local network identifier is the Internet protocol (IP) address, how the IP address will be dealt with concerning in the present invention is described with reference to some of the following drawings, since the local network identifier such as the IP address applied is one of the tough issues in the wireless roaming field, as those skilled in the art can understand. As shown in FIG. 11, under the network 501 environment, the TLC 301 is established on the basis of an underlying link by the interface 800 with an Interface IP: 192.168.0.101; the application IP session being transmitted via the network node 100 and through the TLC is established with termination at the network node 200 with IP address: 172.16.1.67. On the other hand, as shown in FIG. 12, under a network N environment, the TLC N is established on the basis of an underlying link by an interface 900 with interface IP address: 100.10.10.1; the AIS 400 being transmitted via the network node 120 and through the TLC is established with termination at the network node 220 with IP address: 172.17.2.73. FIG. 13 is a diagram with the point of view of a TLC between the network node 100 and 120. The TLC is established between the network node 100 and 120 with termination at interface IP 192.168.0.101 and 100.10.10.1 respectively across the network 500. FIG. 14 is a diagram of the all three TLCs with an additional transportation layer packet header information. The TLC 301 is established between the network node 100 and 120 and terminated at interface IP 192.168.101 and 100.10.10.1 with a network/transportation layer packet header (or TLC tuple) like 192.168.0.101:36021<->100.10.10.1:2000 on the network node 100 side. In some embodiments, if a TLC adopts network address translation (NAT) technology to send packets through intermediate gateway(s) in the middle way toward the network node 120, the packet header should be changed. The TLC 302 is established and terminated at interface IP 10.25.0.1 and 100.10.10.1 with network/transportation layer packet header like 10.25.0.1:64077<->100.10.10.1:2000. The TLC 303 is established and terminated at interface IP 10.200.5.78 and 100.10.10.1 with a network/transportation layer packet header like 10.200.5.78:20107<->100.10.10.1:2000. FIG. 15 is a diagram based on FIG. 14. In FIG. 15, the AIS established between the network nodes 200 and 220 through these multiple TLCs between the network node 100 and 120 is terminated at each end with IP address 172.16.1.67 and IP address 172.17.1.73 respectively.

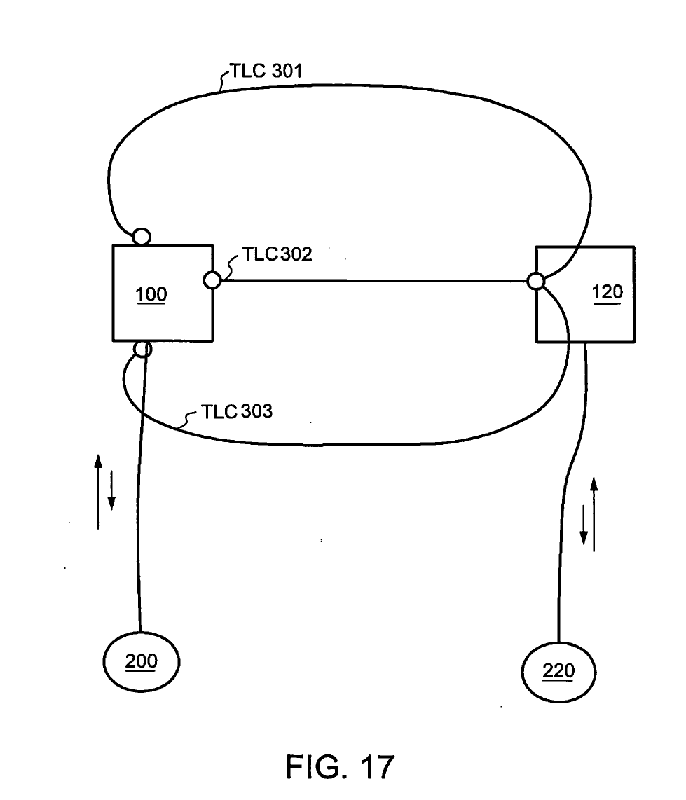

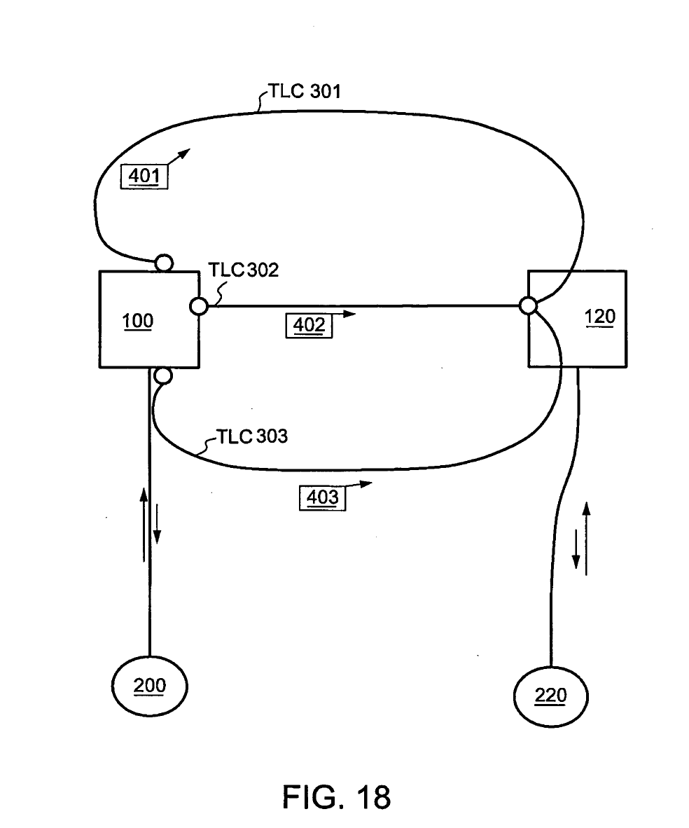

FIG. 16 shows how packets belonging to the AIS established between the network nodes 200 and 220 flow through the multiple TLCs established between the network nodes 100 and 120. The packets 401, 402 and 403 are transmitted from the network nodes 200 to network node 220; and the packets 421, 422 and 423 are transmitted from the network node 220 to network node 200. These packets belong to the AIS, for example, with a network/transportation layer packet header (or application session tuple) like 172.16.1.67:45001<->172.17.2.73:3701. FIG. 17 shows that the AIS between the network node 200 and 220 is routed through these multiple TLCs established between the network node 100 and 120 with previously described AIS session tuple and TLC tuple information. In FIG. 18, the packets 401, 402 and 403 are dispatched to route through, for example, TLC 301, TLC 302 and TLC 303 respectively.

In an embodiment, the network node 100 may be a network device for dispatching of a task through a plurality of connections, such as TLC 301, TLC 302 and TLC 303. The network device may be a server, a gateway, an access point, an electronic device or any device with the capability of dispatching packets in a network environment. The network interfaces of the network device may all be wireless, or some of the network interfaces may be wired. Those interfaces are configured to establish multiple connections with the network node 120, wherein at least one of the connections is wireless. The connections established between the network node 100 and the network node 120 might be direct or indirect. In addition, a new connection may be dynamically established before or after one of the existing connections is broken. In one embodiment of the invention, an interface device comprising a plurality of wireless interfaces with the same technology is used in the network device for establishing a plurality of connections with the network node 120.

Since there are multiple connections established between the network device and the network node, it will be easy to transmit a burst of data while roaming, such as the data of a video communication, between the network device and the network node. In addition, if one of the connections is broken during a hand-off process, the other connections still can provide a seamless communication for the network device. After the hand-off process, a newly established connection can cooperate with the other existing connections to transmit data between the network device and the network node. Therefore, the invention can provide a dynamic roaming through wireless networks between different network systems with seamless quality and has a good capability of processing a burst of data while roaming smoothly.

In one embodiment, a connection is established between the network device 100 and an electronic device, wherein the packet sent to the network node 120 is received from the electronic device. The electronic device may be a mobile phone, a laptop, a PDA, a GPS or any device with capability of connecting to the network device in a network environment.

In one embodiment, the network node 200 can be a local process of the network node 100 and/or the network node 220 can be a local process of the network node 120. In this embodiment, packets belonging to the AIS 400 which network node 200 established locally can be directly dispatched to TLCs 301, 302 and 303.

In one embodiment, the network node 100 can be a local network module of network node 200 and/or the network node 120 can be a local network module of network 220. In this embodiment, packets belonging to the AIS 400 which network node 200 established can be directly dispatched to TLCs 301, 302 and 303.

In one embodiment, the network node 100 may be an electronic device with a network module. The network module comprises a network unit and a transmitting unit for dispatching packets of a task through a plurality of connections. The network unit establishes at least a first and a second connections with the network node 120, wherein at least one of the first and second connection is wireless. The transmitting unit selects a transmitting connection from the first and the second connections to send a packet to the network node 120. The network module may comprise a firmware and/or an IC or may be any readable medium for a processing device. In another embodiment, the network node 100 may be an electronic device with a program product. The program product can be used in the electronic device and makes the electronic device to establish at least a first and a second connections with the network node 120, wherein at least one of the first and second connection is wireless, and select a transmitting connection from the first and the second connections to send a packet to the network node 120.

The selected transmitting connection has a relative low latency and the selection is performed repeatedly. In one embodiment, the packet is sent through the selected transmitting connection, while test packets are sent through the other connections to determine the latencies thereof. Therefore, the next transmitting connection can be selected on the basis of the latency information of all the connections. In another embodiment, a connection which latency is lower than a predetermined threshold can be selected to be the transmitting connection. The predetermined threshold can be repeatedly updated by the lower one or the average of the present latencies of the connections. After sending a packet through the selected transmitting connection, the latency of the selected transmitting connection is updated according to the response time and the next transmitting connection is reselected while sending the next packet according to the updated latencies.

On the basis of aforementioned network device, system and module, a method for dispatching packets of a task from the network node 100 to the network node 120 through a plurality of connections is disclosed. First, at least first and second connections are established between the network node 100 and 120, wherein at least one of the connections is wireless. Then, one of the established connections is selected to be a transmitting connection, wherein the latency of the selected connection is relatively low, to send a packet from the network node 100 to 120 and the selection is performed repeatedly. Further, the latencies of the established connections can be determined before the selection. Test packets can be sent through the established connections to determine their latencies. In another embodiment, a threshold is predetermined and the established connection that has the latency lower than the threshold is selected to be the transmitting connection. The threshold can be updated repeatedly by the lower one or the average of the latencies of the established connections.

What is claimed is:

1. A network device for dispatching packets of a task through a plurality of connections, comprising:
at least a first and a second network interfaces, wherein said first network interface is configured to establish a first connection with a network node, said second network interface is configured to establish a second connection with said network node, at least one of said at least first and second connections is wireless, and at least one of said network device and said network node is movable; and
a transmitting unit configured to select a transmitting connection from said at least first and second connections to send a packet to said network node, wherein said transmitting connection has a relatively low latency, and said selection is performed repeatedly.

2. The network device of claim 1, wherein a connection is established between said network device and an electronic device, wherein said packet sent to said network node is received from said electronic device.

3. The network device of claim 1, wherein said transmitting unit sends test packets through a part of said at least first and second connections to determine the latencies thereof.

4. A network system for dispatching packets of a task through a plurality of connections, comprising:
a network node; and
a network device configured to establish at least a first and a second connections with said network node and select a transmitting connection from said at least first and second connections to send a packet to said network node, wherein said transmitting connection has a relatively low latency, and said selection is performed repeatedly;
wherein at least one of said at least first and second connections is wireless, and at least one said network device and said network node is movable.

5. The network system of claim 4, wherein a connection is established between said network device and an electronic device, wherein said packet sent to said network node is received from said electronic device.

6. The network system of claim 4, wherein said network device sends test packets through a part of said at least first and second connections to determine the latencies thereof.

7. A network module to be used in an electronic device for dispatching packets of a task through a plurality of connections, comprising:
a network unit for establishing at least a first and a second connections with a network node, wherein at least one of said at least first and second connections is wireless, and at least one of said electronic device and said network node is movable; and
a transmitting unit for selecting a transmitting connection from said at least first and second connections to send a packet to said network node, wherein said transmitting connection has a relatively low latency and said selection is performed repeatedly.

8. The network module of claim 7, wherein said transmitting unit causes test packets to be sent through a part of said at least first and second connections to determine the latencies thereof.

9. An electronic device including the network module as claimed in claim 7.

10. An electronic device including the network module as claimed in claim 8.

11. A method for dispatching packets of a task from a first electronic device to a network node through a plurality of connections, wherein at least one of said first electronic device and said network node is movable, comprising:
establishing at least a first and a second connections between said first electronic device and said network node, wherein at least one of said at least first and second connections is wireless; and
selecting a transmitting connection from said at least first and second connections to send a packet from said first electronic device to said network node, wherein said transmitting connection has a relatively low latency and said selecting step is performed repeatedly.

12. The method of claim 11, further comprising sending test packets through a part of said at least first and second connections for determining the latencies thereof.

13. The method of claim 11, further comprising establishing a connection between said first electronic device and a second electronic device, wherein said packet sent to said network node is received from said second electronic device.

14. An interface device, comprising a plurality of wireless interfaces with the same technology for establishing a plurality of connections with a network node.

15. A program product to be used in an electronic device for making said electronic device to perform the processes of:
establishing at least a first and a second connections between said electronic device and a network node, wherein at least one of said at least first and second connections is wireless, and at least one of said electronic device and said network node is movable; and
selecting a transmitting connection from said at least first and second connections to send a packet from said electronic device to said network node, wherein said transmitting connection has a relatively low latency and said selecting process is performed repeatedly.

16. The program product of claim 15, making said electronic device to further perform the process of sending test packets through a part of said at least first and second connections for determining the latencies thereof.
